(19) United States
(12) Patent Application Publication
(10) Pub. No.: US 2009/0304882 A1
(43) Pub. Date: Dec. 10, 2009

(54) SPARKLING AGGLOMERATED SWEETENER, AND METHOD OF MAKING IT

(75) Inventor: Warren L. Nehmer, Decatur, IL (US)

Correspondence Address: RATNERPRESTIA, P.O. BOX 1596, WILMINGTON, DE, 19899, US

(73) Assignee: Tate & Lyle Technology Limited, London (GB)

(21) Appl. No.: 12/300,387

(22) PCT Filed: Apr. 18, 2007
(86) PCT No.: PCT/US07/09378

§ 371 Date: Nov. 11, 2008

(30) Foreign Application Priority Data
May 11, 2006 (US) 11/432594

(51) Int. Cl. A23L 1/236; A23L 1/22

(52) U.S. Cl. 426/285; 426/548

(57) ABSTRACT

A low calorie sweetener composition includes large sucrose crystals and agglomerated particles each containing a high intensity sweetener, a plurality of small sucrose crystals and a binder. The composition may have about one half the bulk density, and about one half the calories on a volume basis, of standard table sugar. The composition typically has a sparkling appearance that causes it to resemble common table sugar, and it may be used in such applications as baking and for sweetening drinks such as coffee, tea, and the like.

### BACKGROUND OF THE INVENTION

High-intensity sweeteners can provide the sweetness of sugar, with various taste qualities. Because they are many times sweeter than sugar, however, much less of the sweetener is required to replace the sugar. High-intensity sweeteners have a wide range of chemically distinct structures and hence possess varying properties.

For example, sucralose (1,6-dichloro-1,6-dideoxy-β-D-fructofuranosyl-4-chloro-4-deoxy-α-D-galactopyranoside) is a high-intensity sweetener made by the selective chlorination of sucrose. Sucralose is a white, crystalline, nonhygroscopic powder in its pure form. It is highly soluble in water, ethanol, and methanol and has a negligible effect on the pH of solutions.

In some applications, it is desired to provide a sweetener that has about half the calories of sugar, but at an equal sweetness level. Such products may be made by combining sucrose with a high intensity sweetener in the proper proportions. However, particularly if the sweetener is to be used directly by consumers for addition to coffee, tea, and the like, it would be beneficial if the sweetener resembled table sugar in appearance. Thus, products having this characteristic would be of value in the sweetener industry.

### SUMMARY OF THE INVENTION

In one aspect, the invention provides a sweetener composition including

a) large sucrose crystals, and

b) agglomerated particles each including a high intensity sweetener, a plurality of small sucrose crystals and a binder. The large sucrose crystals are larger than 400 microns in size and constitute from about 5 wt % to about 50 wt % of the composition, the small sucrose crystals are smaller than 300 microns in size and constitute at least about 25 wt % of the composition, and the binder constitutes at least about 5 wt % of the composition.

In another aspect, the invention provides a method of making a sweetener composition. The method includes the steps of agglomerating a mixture including small sucrose crystals and a binder by treating the mixture with an agglomeration fluid, wherein one or both of the mixture and the agglomeration fluid further comprises a high intensity sweetener; and mixing large sucrose crystals with the small sucrose crystals. The large sucrose crystals are larger than 400 microns in size and constitute from about 5 wt % to about 50 wt % of the composition, the small sucrose crystals are smaller than 300 microns in size and constitute at least about 25 wt % of the composition, and the binder constitutes at least about 5 wt % of the corn position.

In yet another aspect, the invention provides a sweetener composition prepared by the foregoing method.

### BRIEF DESCRIPTION OF THE DRAWINGS

FIG. 1 shows two photographs of exemplary samples of agglomerated sweetener according to the invention.

### DETAILED DESCRIPTION OF THE INVENTION

The present invention discloses low calorie sweetener compositions comprising a mixture of large sucrose crystals and agglomerated particles that comprise a high intensity sweetener, small sucrose crystals and a binder. Due to the presence of the large sucrose crystals, the sweetener compositions have a sparkling appearance resembling that of ordinary table sugar. Despite the visual resemblance, however, the caloric value on a spoon-for-spoon basis is much less (usually about half) than that of table sugar. This is achieved by the presence of the agglomerated particles, which reduce the bulk density of the product. Since the bulk density is lower, the amount of sucrose and binder per spoon is lower, and thus the caloric value is lower. The sweetness equivalence of the composition may be restored to approximately that of table sugar (on a volume basis) by inclusion of an appropriate amount of the high intensity sweetener, which provides negligible (or even zero) caloric value.

The sweetener compositions may be used in any of a variety of applications, including baking and for sweetening beverages such as tea, etc. Details will now be provided regarding the compositions, their ingredients, and the methods of making them.

### Sweetener Composition

Typically, sucrose constitutes at least about 50 wt % of the composition. In order to provide a product with a sufficiently sparkling appearance, the large sucrose crystals usually constitute from about 5 wt % to about 50 wt % of the composition, typically at least about 10 wt % and typically at most about 25 wt %. The small sucrose crystals (in agglomerated form) constitute at least about 25 wt % of the sweetener. Typically, they constitute at least about 35 wt % of the composition. The binder constitutes at least about 5 wt % of the composition. Typically the amount is at least about 20 wt %, and more typically at least about 30 wt % and in some embodiments at least about 35 wt %. The amount of binder is typically at most about 70 wt %, more typically at most about 50 wt % and in some embodiments at most about 45 wt %. In some embodiments, the weight ratio of small sucrose crystals to large sucrose crystals is greater than 1:1, and in most cases will be in a range from 2:1 to 4:1, and especially in a range from 2.5:1 to 3.5:1. It is generally desirable to provide enough large crystals to result in visibly perceptible sparkle and enough binder to provide agglomeration of essentially all of the small crystals, but not so much as to cause binder or small crystals to stick to the large crystals and thereby cloud their surfaces, reducing sparkle. Thus, the overall density (and thus the caloric value per spoonful) of the composition is greatly reduced by the presence of the agglomerated small crystals, while sparkle is provided by the large crystals.

The amount of high intensity sweetener in the composition may vary considerably, but will typically be in a range from-about 0.05 to about 1.0 wt %. In some embodiments of the invention, the amount of high intensity sweetener is adjusted such that the composition has a sweetness equal to that of sucrose on an equal volume basis, based on sucrose having a 0.80 g/cc bulk density. If sucralose is used as the only high intensity sweetener, it will typically constitute at least about 0.15 wt % and more typically at least about 0.20 wt % of the sweetener composition. It will typically constitute at most about 0.35 wt % and more typically at most about 0.30 wt %.

The agglomerated particles formed by the methods of this invention each comprise a plurality of small sucrose particles, binder and high intensity sweetener agglomerated together. Due to the very irregular shape of the agglomerated particles, they are typically of rather low bulk density. If a sufficient amount of such agglomerated particles of sufficiently low density is combined with the large sucrose crystals, the overall net density will be approximately half that of ordinary table sugar. Typically, essentially all small sucrose crystals in the composition are in the agglomerated particles, although this is not required.

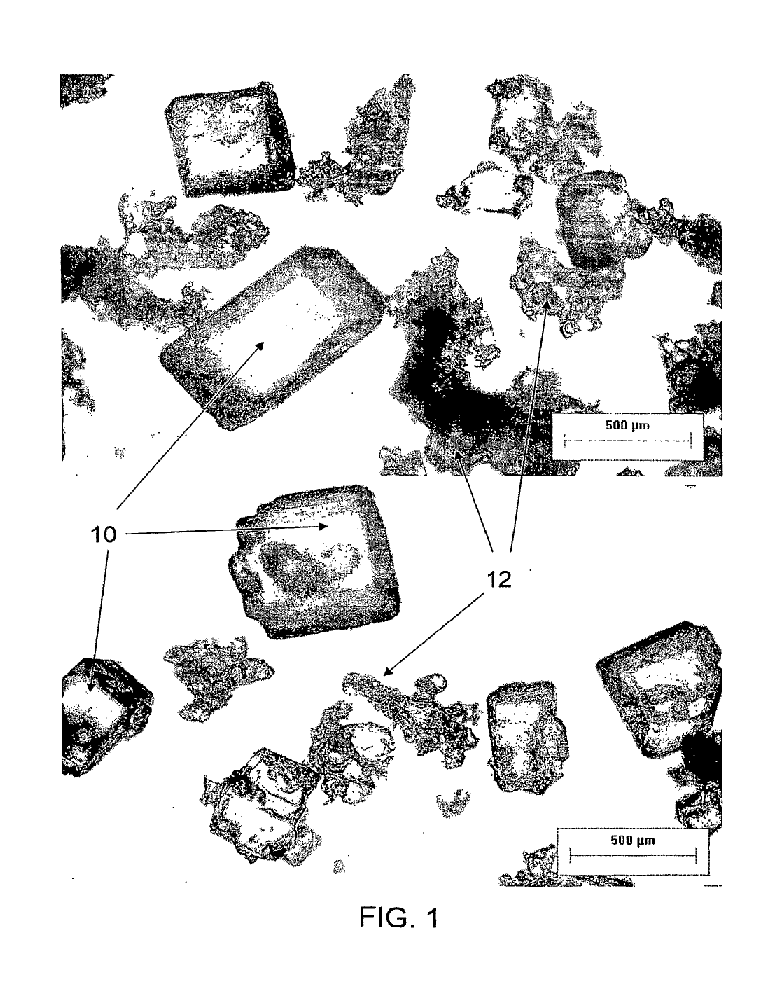

FIG. 1 shows two photographs of exemplary samples of agglomerated sweetener according to the invention, viewed at 40× magnification. Large sucrose crystals (Domino Granular) can be seen at 10, and agglomerates composed of sucralose, maltodextrin, and small sucrose crystals (Domino Extra Fine Granular) can be seen at 12. It can be seen that the agglomerates may be rather large compared to the size of the sucrose and maltodextrin particles constituting them, and are of very irregular shape. These are thought to produce a white but matte appearance, while the large sucrose crystals can be seen to have fairly large and flat sides, relatively devoid of visible adhered particles. These are thought to produce the sparkling appearance of the product.

The published bulk density of granulated sugar is 50 to 65 lbs/cubic foot, equivalent to 0.80 to 1.04 g/cc. By comparison, the sweetener compositions of this invention typically have a bulk density of at most 0.50 g/cc, and more typically at most 0.45 g/cc. The bulk density will typically be at least 0.30 g/cc, more typically at least 0.35 g/cc. This low bulk density is thought to be made possible by the presence of a substantial amount of the agglomerates which, as seen in FIG. 1, are very irregular in shape and therefore do not pack closely.

A notable aspect of the present sweetener compositions is that, even if the large sucrose crystals are included at the start in the agglomeration process, they typically remain essentially free of binder particles or small sucrose particles attached to their surface, when visually inspected under an optical microscope at 40× magnification. Typically, at least half of the total surface area of the large sucrose crystal portion of the sweetener is free of adhered binder particles or small sucrose particles. It is believed that the sparkling quality of the product is made possible by this relative absence of material stuck to the surface of the large sucrose crystals, thereby preserving the presence of large flat crystal surfaces capable of providing specular reflection of light.

Sweetener compositions according to the invention may be of any particulate size. In some embodiments, the size will be such that the product resembles ordinary table sugar in appearance. In such cases, the particles will typically have a mean particle size between 100 and 2000 μm, more typically between 150 and 1000 μm, as determined by screening. At least about 95 wt % of the composition can typically pass through a 3000 μm screen, more typically at least about 95 wt % will pass through a 1500 μm screen. If necessary the composition may be sieved to achieve this.

### Sucrose

Sources of sucrose suitable for use in preparing the sweetener compositions of this invention include any commonly available source, such as, for example, beet sugar and cane sugar. They may include white sugar or brown sugar. A combination of at least two size ranges of sucrose crystals are used to make the sweetener compositions. These are referred to herein as “large” and “small” sucrose crystals, respectively. Large sucrose crystals are those that are greater than 400 microns in size. Small sucrose crystals, as fed to the process prior to being agglomerated, are smaller than 300 microns in size. In some embodiments, they are smaller than 200 microns, or even smaller than 150 microns. The agglomerates that form from these small crystals are of course significantly larger in size, as can be seen in FIG. 1.

No special preparation of the large sucrose crystals need be made, but it may be helpful to use large sucrose crystals of a relatively uniform size in order to provide an appearance more nearly resembling ordinary table sugar. Commercially available sucrose granules from any of a wide variety of sources known in the art may be used, and are typically sieved before use in order to achieve a relatively uniform size distribution. The large sucrose crystals are therefore essentially solid, and are typically of such a size and shape that they resemble common table sugar. A typical (but non-limiting) size distribution for the large sucrose crystals is as follows: no more than about 30% retained on a 20-mesh (841 micron) screen, a minimum of about 8% (cumulative) retained on a 40-mesh (420 micron) screen, and no more than about 10% passing through a 100-mesh (149 micron) screen.

Examples of suitable large crystal sucrose include Domino Granular, available from Domino Sugar Company (New York, N.Y.), most of which is retained on a 30-mesh (595 micron) screen, with most of the rest retained on a 40-mesh (420 micron) screen.

Suitable small crystal sucrose may for example be of such a size that most of it passes through a 100-mesh (149 micron) screen and essentially all of it passes through a 40-mesh (420 micron) screen. Such sucrose may be obtained by milling, or may be any suitable commercially available material. For example, a significant portion of Domino Extra Fine Granular sugar meets these requirements, and material that is too large may be screened out or, to the extent that it is larger than 400 microns, included as part of the large crystal sucrose portion of the composition.

### Binders

Typical binders suitable for use according to the invention are carbohydrates or derivatives thereof. Exemplary binders suitable for use according to the invention include, but are not limited to, edible carbohydrates such as fructose, invert sugar, dextrose, maltodextrin, and combinations of any of these. Other suitable binders include, as non-limiting examples, maltose, polyols (e.g., sugar alcohols, such as erythritol and sorbitol), modified food starches, gum, inulin or hydrolyzed inulin, corn syrup solids, polydextrose, and combinations of these.

### High Intensity Sweeteners

Any high intensity sweetener known in the art may be used to make the sweetener compositions of this invention. Exemplary high intensity sweeteners include, but are not limited to, saccharin, acesulfame-κ, cyclamate, stevia, neotame, alitame, aspartame, and combinations of such sweeteners. In some embodiments, the high intensity sweetener is sucralose, either alone or in combination with another high intensity sweetener.

### Methods of Preparing the Sweetener Compositions

General processes for preparing the sweetener compositions of this invention will now be described. For sake of clarity and simplicity, sucralose will be recited as the high intensity sweetener. However, it will be understood that the methods apply also to any other high intensity sweetener.

Sweetener compositions according to some embodiments of the invention may be produced by fluidizing a mixture of sucrose and a binder (for example, maltodextrin) on a fluid bed agglomerator such as a GPCG-1 or a GPCG-300 Batch Fluid Bed Agglomerator (both available from Glatt Air Techniques, Inc. of Ramsey, N.J.), and spraying an aqueous (or other) liquid (referred to herein as the “agglomeration fluid”) on the fluid bed to agglomerate the small sucrose particles. In some embodiments, some or all of the high intensity sweetener (e.g., sucralose) will be dissolved or suspended in the agglomeration fluid. Alternatively, the agglomeration fluid may not contain sucralose, but rather the sucralose may be added as a dry ingredient along with the small sucrose crystals. In such a case the sucralose may be added as a separate dry material, or incorporated in or on the small sucrose crystals. Or, it may be incorporated with the binder, for example by co-spray drying sucralose with maltodextrin. During the process, at least the small sucrose crystals are fluidized on the bed and the agglomeration fluid is applied to the crystals while simultaneously drying the resultant wet particles.

The sucrose crystals charged to the agglomerator may contain both the large crystal sucrose component and the small crystal sucrose component before agglomeration begins, or the large crystal component may be added later during the agglomeration process or after it, i.e. dry blended. In the latter case, essentially all of the sucralose will be in/on the agglomerated particles, with essentially none on the large sucrose particles. In such a case, there may of course be sucralose loosely attached to the large sucrose crystals as small dust-like particles, due to dust formation during handling, but there will be no surface coating of sucralose on the large sucrose crystals. However, even in the case where the large sucrose crystals are part of the agglomeration mixture from the start, the majority of the sucralose ends up in/on the agglomerated particles containing the small sucrose crystals and the binder. In most cases, at least about 75 wt % of the sucralose will reside there.

Typically, the only ingredients of the agglomeration fluid are a solvent (usually water) and optionally sucralose. In those cases where sucralose is included in the agglomeration fluid, the amount will typically be between about 1 wt % and about 10 wt % of dissolved sucralose, more typically between about 3 wt % and about 6 wt %, although any concentration may be used.

In general, temperatures during agglomeration should be kept low to protect the sucralose from chemical degradation. The GPCG-1 or -300 fluid bed unit may be operated in normal fluid bed agglomeration mode (top spray or bottom spray).

The agglomeration process may be either batch or continuous, and various types of commercially available equipment may be used to prepare the product. In some embodiments, a continuous moving bed fluidizer is used, an exemplary model being the Glatt model GFG 20. The agglomeration process is typically run at a temperature between 40° C. and 50° C., although this is not critical. In addition to the fluidized bed method described above, nonlimiting examples of other suitable equipment include Littleford mixers and pan agglomerators.

Other variations on the above procedures are also possible, and the order of addition of ingredients is generally not critical to preparing the sweetener compositions of this invention. In some embodiments, preparation involves agglomerating extra fine granular sugar with maltodextrin and sucralose and then dry blending large granular sucrose into the agglomerated particles to produce a shiny product. The sweetener composition may also be produced by agglomerating milled (powdered) sugar with maltodextrin and sucralose and then dry blending large sucrose crystals to produce a shiny final product. Other variations on the processes described above will be apparent to the person of skill in the art, and also fall within the scope of this invention.

### EXAMPLES

### General Procedures

Particle size measurements were determined using a RoTap® screener. Different screen sizes were chosen based on the desired particle size of the product. The screens were placed on a pan to collect the fines. The top of the particle size table was fastened on to the screen stack and the operation was started. After 10 minutes, the screens were removed and weighed to determine percent of product on designated screen. The results were then recorded as a percentage of total weight loaded on to screens.

Moisture determination was performed on a Sartorius moisture balance. First, the weigh pan was tared and approximately 2 grams of material was spread evenly over the balance pan. The sample was then heated up to a temperature of 100° C. After 10 minutes, the loss on drying was determined and the percent moisture based on initial weight was displayed. The results were recorded as percent of as-is sample.

Loose bulk density measurements were performed using a typical funnel and cup method, such as is well known in the art. The sample cup was tared, and the sucralose sample was added to the hopper until it was full. The tared sample cup was placed under the hopper and the hopper was unloaded into the sample cup. Using a long blade scraper, the excess sample was scraped off the top of the sample cup. Care was taken not to shake or tap the sample cup so that there was minimal packing. The full sample cup was then weighed to determine the loose bulk density of the product. The results were recorded as grams per cubic centimeter.

### Example 1

### Sparkling Agglomerated Sweetener Preparation and Properties

Several batches of sweetener composition were produced using a GPCG-300 Batch Fluid Bed Agglomerator (Glatt Air Techniques, Inc. of Ramsey, N.J.). The following materials were charged to the fluid bed at the start of each batch:

67.5 kg extra fine granular sugar (Domino Extra Fine)

60 kg maltodextrin (Star-Dri 1015A, Tate & Lyle, Decatur, Ill.)

22.5 kg granular sugar (Domino Granular)

The agglomeration fluid, which was composed of 8 kg of water and 0.33 kg of sucralose, was applied using the following settings for the fluid bed agglomerator:

Spray interval=30 seconds

Inlet air temperature=70-85° C. (Target 75° C.)

Atomization air pressure=1.7-2.3 (Target 2.0)

Air Volume=1700-2400 cfm (Target 200)

Spray rate=600-1000 g/min (Target 800)

Shake duration=5 seconds

Nozzle position=#1

Ports=1.2 mm×3 head

Table 1 summarizes the results from several batch tests, all run under the same conditions.

TABLE 1

| | Batch # | | | | |
|---|---|---|---|---|---|
| Screen | PD050478 | PD050479 | PD050480 | PD050481 | PD050482 |
| 20 | 7.3 | 8..3 | 8.2 | 7.4 | 7.6 |
| 30 | 22.6 | 23.2 | 24.3 | 25 | 23 |
| 40 | 29.7 | 29.3 | 31.1 | 31.6 | 30 |
| 60 | 27.2 | 26 | 27 | 26.3 | 27 |
| 100 | 9.3 | 8.8 | 8 | 7.5 | 8.7 |
| Pan | 3.7 | 4.5 | 1.5 | 2.1 | 3.7 |
| Total | 99.8 | 100.1 | 100 | 99.9 | 100 |
| BD g/cc | 0.39 | 0.38 | 0.37 | 0.37 | 0.4 |
| BD lbs/ft³ | 24.35 | 23.73 | 23.1 | 23.1 | 24.98 |
| Moisture | 2.10% | 1.88% | 2.20% | 2.30% | 2.70% |
| Oversize | 0 | 0 | 0 | 0 | 0 |
| Net Yield | 148.20 kg | 148.90 kg | 150.30 kg | 149.60 kg | 149.80 kg |

Batch #

| Screen | PD050483 | PD050484 | PD050485 | PD050486 |
|---|---|---|---|---|
| 20 | 4.9 | 7.1 | 5.2 | 8.4 |
| 30 | 19.8 | 22.7 | 19.5 | 23.5 |
| 40 | 31.3 | 31 | 30.4 | 30.3 |
| 60 | 30.5 | 28.1 | 31.2 | 26.9 |
| 100 | 10.5 | 8.8 | 10.6 | 8.9 |
| Pan | 3.1 | 2.3 | 3.1 | 2.3 |
| Total | 100.4 | 100 | 100 | 100.3 |
| BD g/cc | 0.38 | 0.39 | 0.41 | 0.37 |
| BD lbs/ft³ | 23.73 | 24.35 | 25.6 | 23.1 |
| Moisture | 2.60% | 2.20% | 1.81% | 2.50% |
| Oversize | 0 | 0 | 0 | 0 |
| Net Yield | 147.95 kg | 149.50 kg | 147.65 kg | 150.25 kg |

In all cases, the product had a sparkling appearance resembling that of ordinary table sugar, due to the presence of the large granular sucrose crystals.

### Example 2

A sensory panel was assembled to subjectively assess the “sparkliness” of two batches of agglomerated sweetener made according to the invention, using the same equipment and conditions as described in Example 1. One batch was made using the same formulation as in Example 1, but using Domino Extra Fine Granular sugar for the entire sucrose load (i.e., using it as the small crystal sucrose component and replacing the Domino Granular with it as well). The resulting product is indicated in the following tables as “Domino Extra Fine Granular.” The other sample used Redpath Sanding Sugar (a relatively coarse sugar of particle size greater than 400 microns, available from Tate & Lyle) to replace only the Domino Granular component, and is labeled “Redpath Sanding Sugar” in the tables. Panelists were also asked to choose which sample they thought most looked like table sugar. Testing of these batches was done under two different lighting conditions. In the first test, panelists viewed the sample under room lighting alone, while in the second test the panelists viewed the samples under the same room lighting but with additional illumination from a flashlight. The results of the 10-member panel tests are show below.

Test 1 - Room Lighting

| Sparkliness | |
|---|---|
| Domino Extra Fine Granular | 0 |
| Redpath Sanding Sugar | 10 |
| More like sugar | |
| Domino Extra Fine Granular | 4 |
| Redpath Sanding Sugar | 6 |

Test 2 - Room Lighting with flashlight

| Sparkliness | |
|---|---|
| Domino Extra Fine Granular | 1 |
| Redpath Sanding Sugar | 9 |
| More like sugar | |
| Domino Extra Fine Granular | 3 |
| Redpath Sanding Sugar | 7 |

Combined Results

| Sparkliness | |
|---|---|
| Domino Extra Fine Granular | 1 |
| PD060400-Redpath Sanding | 19 |
| More like sugar | |
| Domino Extra Fine Granular | 7 |
| Redpath Sanding Sugar | 13 |

As can be seen from the panel testing results, the agglomerated sweetener incorporating both small and large sucrose crystals were judged more like table sugar, and of significantly higher sparkliness, than the sweetener in which only sucrose of small crystal size was used.

Although the invention is illustrated and described herein with reference to specific embodiments, it is not intended that the subjoined claims be limited to the details shown. Rather, it is expected that various modifications may be made in these details by those skilled in the art, which modifications may still be within the spirit and scope of the claimed subject matter and it is intended that these claims be construed accordingly.

What is claimed:

1. A sweetener composition comprising
a) large sucrose crystals, and
b) agglomerated particles each comprising a high intensity sweetener, a plurality of small sucrose crystals, and a binder;
wherein the large sucrose crystals are larger than 400 microns in size and constitute from about 5 wt % to about 50 wt % of the composition, and wherein the small sucrose crystals are smaller than 300 microns in size and constitute at least about 25 wt % of the composition and the binder constitutes at least about 5 wt % of the composition.

2. The sweetener composition of claim 1, wherein essentially all small sucrose crystals in the composition are in the agglomerated particles.

3. The sweetener composition of claim 1, wherein the large sucrose crystals constitute from about 5 wt % to about 25 wt % of the composition.

4. The sweetener composition of claim 1, wherein the high intensity sweetener comprises sucralose.

5. The sweetener composition of claim 1, wherein sucrose constitutes at least about 50 wt % of the composition.

6. The sweetener composition of claim 1, wherein the large sucrose crystals constitute at least about 10 wt % of the composition.

7. The sweetener composition of claim 1, wherein the small sucrose crystals are smaller than 200 microns in size.

8. The sweetener composition of claim 1, wherein the small sucrose crystals are smaller than 150 microns in size.

9. The sweetener composition of claim 1, wherein at least about 75 wt % of the high intensity sweetener in the composition is incorporated in the agglomerated particles.

10. The sweetener composition of claim 1, wherein the large sucrose crystals are substantially free of a surface coating of the high intensity sweetener.

11. The sweetener composition of claim 1, wherein at least about 50% of the total surface of the large sucrose crystals is free of visible adhered particles by inspection under an optical microscope at 40× magnification.

12. The sweetener composition of claim 1, wherein a bulk density of the composition is in a range from about 0.30 to about 0.50 g/cc.

13. The sweetener composition of claim 1, wherein a bulk density of the composition is in a range from about 0.35 to about 0.45 g/cc.

14. The sweetener composition of claim 1, wherein at least about 95 wt % of the composition can pass through a 1500 micron screen.

15. The sweetener composition of claim 1, wherein the binder comprises maltodextrin.

16. The sweetener composition of claim 1, wherein the high intensity sweetener comprises sucralose, the large sucrose crystals constitute at least about 10 wt % of the composition, sucrose constitutes at least about 50 wt % of the composition, and the composition has a bulk density in a range from about 0.35 to about 0.45 g/cc.

17. A method of making a sweetener composition, the method comprising the steps of:
agglomerating a mixture comprising small sucrose crystals and a binder by treating the mixture with an agglomeration fluid comprising a solvent, wherein one or both of the mixture and the agglomeration fluid further comprises a high intensity sweetener; and
mixing large sucrose crystals with at least the small sucrose crystals and the binder;
wherein the large sucrose crystals are larger than 400 microns in size and the small sucrose crystals are smaller than 300 microns in size.

18. The method of claim 17, wherein the large sucrose crystals constitute from about 5 wt % to about 50 wt % of the composition, the small sucrose crystals constitute at least about 25 wt % of the composition, and the binder constitutes at least about 5 wt % of the composition.

19. The method of claim 17, wherein the large sucrose crystals constitute from about 5 wt % to about 25 wt % of the composition.

20. The method of claim 17, wherein the step of mixing the large sucrose crystals with at least the small sucrose crystals and the binder is performed prior to or concurrently with the agglomeration step.

21. The method of claim 17, wherein the high intensity sweetener comprises sucralose.

22. The method of claim 17, wherein the binder comprises maltodextrin.

23. The method of claim 17, wherein the step of agglomerating comprises
a) fluidizing at least the small sucrose crystals and the binder on a fluidized bed; and
b) applying to at least the small sucrose crystals and the binder an agglomeration fluid while simultaneously drying the resultant wet particles.

24. The method of claim 17, wherein the agglomeration fluid is aqueous.

25. A sweetener composition prepared by the method of claim 17.

26. A sweetener composition comprising
a) large sucrose crystals, and
b) agglomerated particles each comprising a high intensity sweetener, a plurality of small sucrose crystals, and a binder;
wherein the large sucrose crystals are larger than 400 microns in size and the small sucrose crystals are smaller than 300 microns in size, and wherein the composition has a visibly perceptible sparkle.

27. The sweetener composition of claim 26, wherein at least about 50% of the total surface of the large sucrose crystals is free of visible adhered particles by inspection under an optical microscope at 40× magnification.

28. The sweetener composition of claim 26, wherein a bulk density of the composition is in a range from about 0.30 to about 0.50 g/cc.

29. The sweetener composition of claim 26, wherein sucrose constitutes at least about 50 wt % of the composition.

30. The sweetener composition of claim 26, wherein the large sucrose crystals constitute at least about 10 wt % of the composition.

31. The sweetener composition of claim 26, wherein the binder comprises maltodextrin.

32. The sweetener composition of claim 26, wherein the high intensity sweetener comprises sucralose.

33. The sweetener composition of claim 26, wherein at least about 75 wt % of the high intensity sweetener in the composition is incorporated in the agglomerated particles.

34. The sweetener composition of claim 26, wherein the large sucrose crystals are substantially free of a surface coating of the high intensity sweetener.

35. The sweetener composition of claim 26, wherein at least about 95 wt % of the composition can pass through a 1500 micron screen.

36. The sweetener composition of claim 26, wherein essentially all small sucrose crystals in the composition are in the agglomerated particles.
